(19) United States
(12) Patent Application Publication
(10) Pub. No.: US 2002/0034413 A1
(43) Pub. Date: Mar. 21, 2002

(54) Connecting member

(76) Inventor: Lien-Huang Liu, Feng-Yang City (TW)

Correspondence Address: DOUGHERTY & TROXELL, ONE SKYLINE PLACE, SUITE 1404, 5205 LEESBURG PIKE, FALLS CHURCH, VA, 22041, US

(21) Appl. No.: 09/818,553

(22) Filed: Mar. 28, 2001

(30) Foreign Application Priority Data
Aug. 31, 2000 (TW) 089215085

(51) Int. Cl. F16B 1/00; F16P 5/00; F16D 9/00

(52) U.S. Cl. 403/2

(57) ABSTRACT

Connecting member including a column-shaped driven section, a cylindrical connecting section for connecting with a screwing tap, a bit or a socket and a column-shaped body section connected between the driven section and the connecting section. The body section or the connecting section is formed with a weakened section as a stress concentration area when the connecting member is subject to a torque. The weakened section has a cross-sectional area smaller' than that of other parts of the connecting member. The connecting member is co-used with a screwing tap or a bit. In case of over-screwing, the weakened section is first broken so that the relatively expensive screwing tap or other tools or the parts driven by the tools are prevented from breaking or deforming.

### BACKGROUND OF THE INVENTION

The present invention relates to a connecting member co-usable with tools such as a screwing tap, a socket or a bit, and more particularly to a connecting member having a weakened section. In case of over-forcing or abnormal operation of the tools, by means of the weakened section, the cheaper connecting member is first broken so that the relatively expensive tools or other relevant parts are prevented from breaking or damaging.

A conventional screwing tap is manually or automatically operated to form a thread blind hole or thread through hole on a metal work piece. The screwing tap has a stem with a considerable length. A working section with a certain length is axially formed on one end of the screwing tap. The working section has cutting teeth for cutting the work piece. A holding section is formed at the other end of the screwing tap opposite to the working section. A user can hold the holding section with a suitable tool for continuously turning the screwing tap.

In use, the screwing tap is positioned in a hole with an inner diameter smaller than the outer diameter of the screwing tap. Then the screwing tap is continuously turned to cut off the inner wall of the hole and exhaust the cutting chip. In order to facilitate operation, the end of the working section is tapered and formed-with a thrust face. It often takes place that when turning the screwing tap, the end of the working section inside the hole breaks and the broken fragment of the screwing tap tightly blocks the hole at a considerable depth. It is hard to extract the broken fragment from the hole and this makes it impossible to further process the hole.

In order to solve the above problem, U.S. Pat. No. 5,299,105 discloses a measure by which a lubricant is filled into the thread hole for more easily taking out the broken fragment of the screwing tap from the thread hole. However, the lubricant is difficult to infiltrate into the thread so that such measure achieves quite limited effect. U.S. Pat. No. 5,934,385 discloses a measure using pressurized fluid for controlling or driving the screwing tap. Such measure has complicated structure and is quite expensive and can be hardly popularly used.

In Taiwan there is a discharging technique for processing the broken end of the screwing tap and forming a channel thereon. A user can insert a screwdriver into the channel to take out the end of the screwing tap in reverse direction.

Such measure is applicable only after the screwing tap is broken and it is still impossible to previously prevent the screwing tap from breaking and clogging the work piece. Moreover, in the case that the work piece is quite huge or heavy, it will be troublesome to use the discharging implement in cooperation with the workpiece and it is time-consuming to perform the processing operation.

### SUMMARY OF THE INVENTION

It is therefore a primary object of the present invention to provide a connecting member which can be co-used with a screwing tap to prevent the screwing tap from being damaged.

It is a further object of the present invention to provide the above connecting member which can be co-used with a bit and a socket to prevent the bit or a part driven by the bit from being damaged.

It is still a further object of the present invention to provide the above connecting member co-usable with various kinds of tools. In case of over-forcing or abnormal operation of the tools, the connecting member will be first broken so that the tools or the parts driven by the tools are protected from breaking or damaging.

It is still a further object of the present invention to provide the above connecting member which can be further used after broken.

According to the above objects, the connecting member of the present invention includes:

a body section having a predetermined length and cross-sectional shape;

a driven section formed at one end of the body section and having a predetermined outer circumferential shape for a holding tool or a socket to hold the connecting member;

a connecting section formed at the other end of the body section opposite to the driven section and spaced from the driven section by a certain distance, the connecting section being formed with a socket inward extending from a lower end of the connecting section by a predetermined depth, the socket having a predetermined inner circumferential shape; and

a weakened section formed on a predetermined portion of the connecting member, the weakened section having a torque strength less than that of other parts of the connecting member. The connecting member is co-used with a screwing tap or a bit. In case of over-screwing, the weakened section is first broken so that the relatively expensive screwing tap or the bit or the screw driven by the bit is prevented from breaking or deforming.

The present invention can be best understood through the following description and accompanying drawings wherein:

### BRIEF DESCRIPTION OF THE DRAWINGS

FIG. 1 is a perspective assembled view of a first embodiment of the connecting member of the present invention, showing that the connecting member is co-used with a screwing tap;

FIG. 2 is a perspective exploded view of the first embodiment of the connecting member of the present invention according to FIG. 1;

FIG. 3 is a sectional assembled view of the first embodiment of the connecting member of the present invention, showing that the connecting member is co-used with the screwing tap;

FIG. 4 is a perspective view of a second embodiment of the present invention;

FIG. 5 is a perspective view of a third embodiment of the present invention;

FIG. 6 is a perspective view of a fourth embodiment of the present invention; and

FIG. 7 is a perspective view of a fifth embodiment of the present invention.

### DETAILED DESCRIPTION OF THE PREFERRED EMBODIMENTS

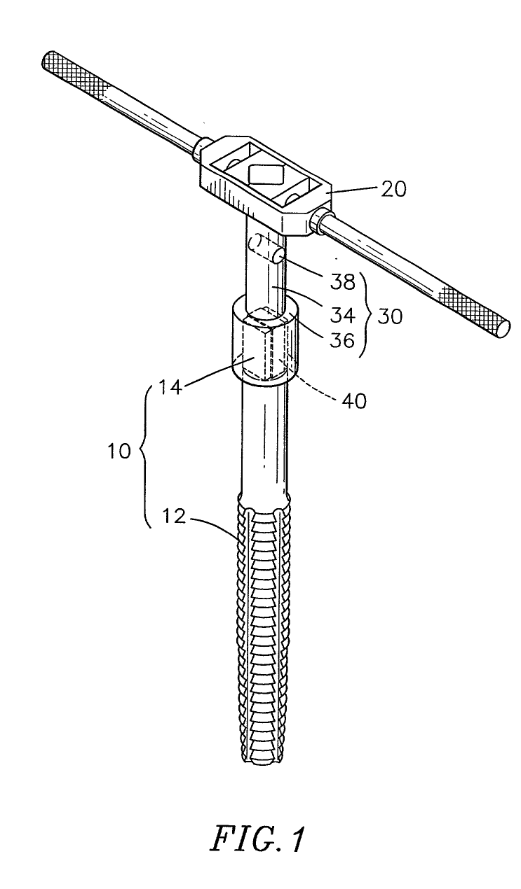

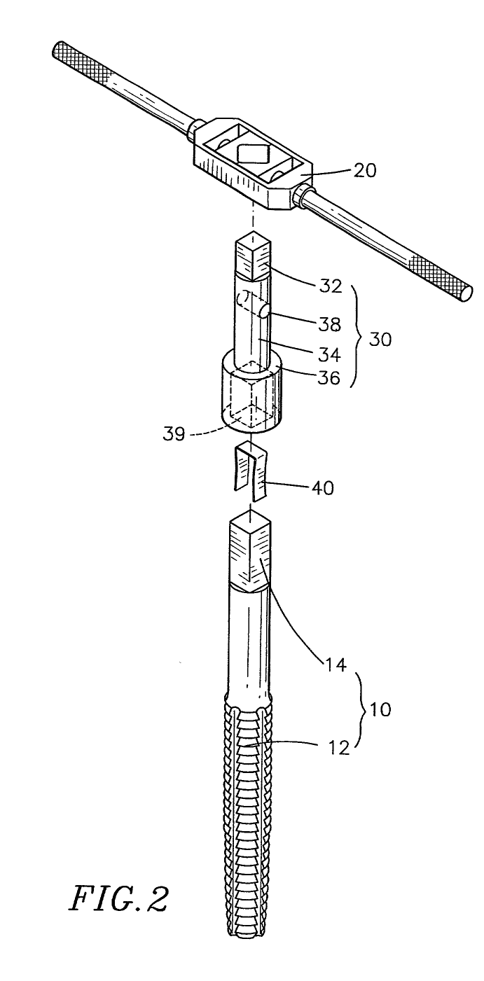

Please refer to FIGS. 1 to 3. A conventional screwing tap 10 is co-used with a holding member 20 and a connecting member 30 of the present invention.

The screwing tap 10 has a working section 12 at lower end for cutting inner thread on the wall of a hole 52 of a work piece 50. The screwing tap 10 further has a holding section 14 at upper end for a user to hold with the holding member 20.

The connecting member 30 has a certain length, including from upper side to lower side a driven section 32, a body section 34 and a connecting section 36.

The driven section 32 is rectangular column-like and can be held by the holding member 20. The body section 34 is a cylindrical rod and downward extends from the lower end of the driven section 32 by a certain length. The connecting section 36 is a cylindrical section downward extending from the lower end of the body section 34. The outer diameter of the connecting section 36 is larger than the outer diameter of the body section 34. The connecting section 36 is formed with a socket 39 upward extending from lower end of the connecting section 36 by a certain depth. A reverse U-shaped resilient member 40 is fixed in the socket 39.

The connecting member 30 is characterized in that the body section 34 is formed with a weakened section 38 having a through hole passing through two opposite sides of the body section 34. Therefore, the weakened section 38 has a cross-sectional area smaller than that of other parts of the connecting member 30. In the case that the entire connecting member 30 is made of unified material and has unified strength per unit area, the weakened section 38 will have a torque strength less than that of other parts.

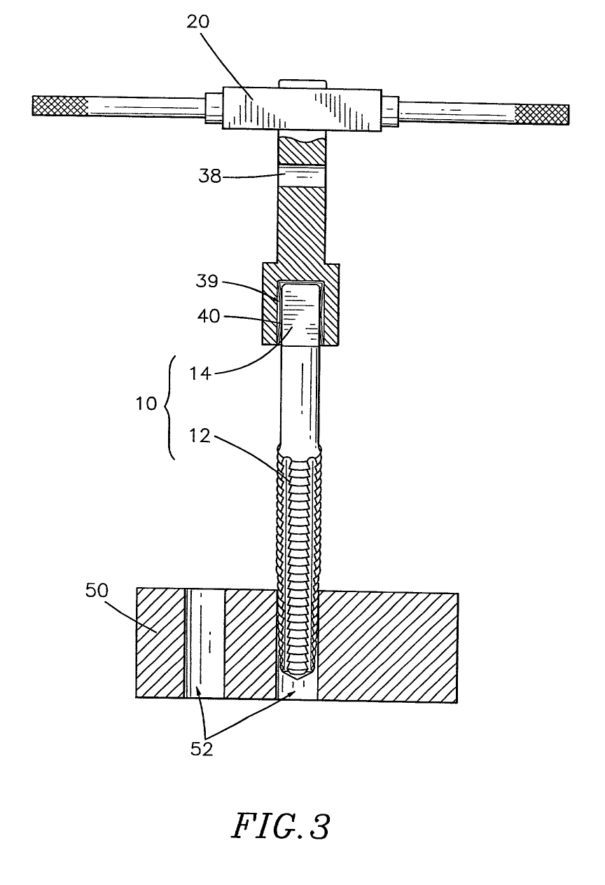

In use of the connecting member 30, the holding member 20 is used to hold the driven section 32 and the holding section 14 of upper end of the screwing tap 10 is fitted into the connecting section 36. The resilient member 40 resiliently clamps the holding section 14 and prevents the same from detaching from the connecting section 36. As shown in FIG. 3, a user can operate the holding member 20 to drive the connecting member 30 for drivingly turning the screwing tap 10. At this time, the working section 12 of the screwing tap 10 is extended into a hole 52 of the work piece 50 to cut off the inner wall of the hole 52 so as to form a thread hole. In case of over-forcing during the screwing operation, the weakened section 38 with lowest torque strength will immediately break.

According to the above arrangement, once breakage takes place during operation, the breakage is most likely to happen at the weakened section 38. Therefore, only the connecting member 30 which is made at lowest cost will be lost, while the relatively expensive screwing tap 10 will remain unharmed.

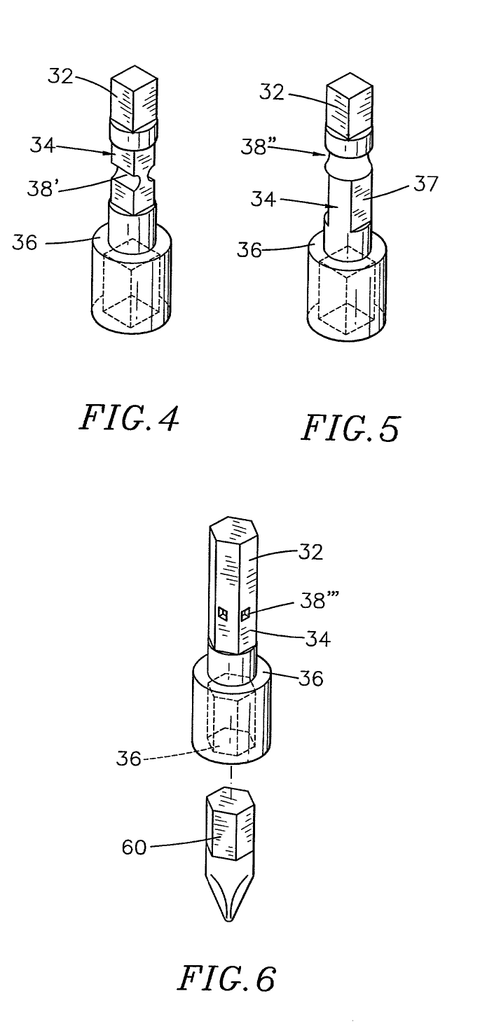

Referring to FIG. 4, the weakened section 38 has two parallel channels 38′ and the body section 34 is a rectangular column as the driven section 32. A part of the rectangular column extends between the weakened section 38 and the connecting section 36. Accordingly, once the weakened section 38 is broken, the user can still use the same holding member 20 to hold the rectangular column of the body section 34 remaining between the weakened section 38 and the connecting section 36 so as to further operate the screwing tap 10 or extract the screwing tap 10 from the work piece 50.

In FIG. 5, the weakened section 38 has an annular groove 38″ with a certain depth. The body section 34 is substantially cylindrical and a pair of opposite plane sections 37 with a certain width are formed on the outer circumference of the body section 34. The plane sections 37 are spaced from each other by 180 degrees and axially extend by a certain length After the weakened section 38 is broken, the user can still use a pincers or an adjustable wrench to clamp the plane sections 37 for further operating the screwing tap 10.

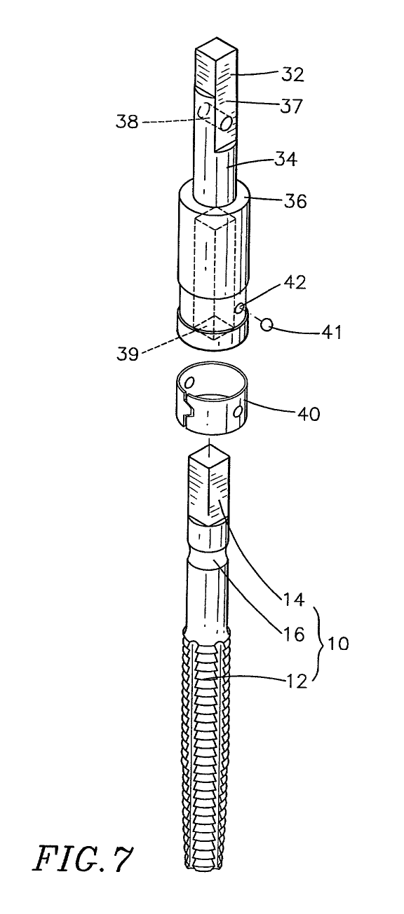

Referring to FIG. 6, the driven section 32 and the body section 34 are both hexagonal column-shaped. The weakened section 38 has multiple dents 38″ formed on the circumference of the body section 34 and spaced from the connecting section 36 by a certain distance. The socket 39 is also hexagonal. Accordingly, the driven section 32 of the connecting member 30 can be co-used with a socket wrench and the connecting section 36 can be connected with a bit 60. In the case that the connecting member 30 is co-used with a bit, the head section of the driven screw is prevented from being damaged due to over-screwing.

In FIG. 7, the resilient member 40 is hoop-shaped and fitted around the connecting section 36. The connecting section 36 is formed with multiple perforations 42 passing through the inner and outer circumferences of the connecting section 36. A steel ball 41 is inlaid in one of the perforations 42. The resilient member 40 serves to resiliently force the steel ball 41 to partially slightly protrude into the socket 39 for abutting against a dent or annular groove 16 formed on outer circumference of a screwing tap or a bit so as to locate the same. In this embodiment, the perforations 42 form a weakened section with smaller cross-sectional area on the connecting section 36.

The measure for reducing the cross-sectional area of the weakened- section 38 is not limited to the above embodiments. Other measures for forming a stress concentration area on the body section 34 are also included in the scope of the present invention, such as those measures for reducing a certain amount of material of the outer or inner circumference of the body section 34 or forming the body section 34 with weaker material or forming a specific curved portion on the body section 34. The stress concentration area can be formed on an adjoining section between the rectangular column and cylindrical column of the body section 34 as shown in FIG. 4 or an adjoining section between the body section 34 and the driven section 32 and an adjoining section between the body section 34 and the connecting section 36. Alternatively, the weakened sections 38, 38′ can be changed from circular hole or semicircular groove into rectangular hole or rectangular groove (not shown).

The above embodiments are only used to illustrate the present invention, not intended to limit the scope thereof. Many modifications of the above embodiments can be made without departing from the spirit of the present invention.

What is claimed is:

1. Connecting member comprising:
a body section having a predetermined length and cross-sectional shape;
a driven section formed at one end of the body section and having a predetermined outer circumferential shape for a holding tool or a socket to hold the connecting member;
a connecting section formed at the other end of the body section opposite to the driven section and spaced from the driven section by a certain distance, the connecting section being formed with a socket inward extending from a lower end of the connecting section by a predetermined depth, the socket having a predetermined inner circumferential shape; and
a weakened section formed on a predetermined portion of the connecting member, the weakened section having a torque strength less than that of other parts of the connecting member.

2. Connecting member as claimed in claim 1, wherein the weakened section is formed on an adjoining section between the body section and the driven section.

3. Connecting member as claimed in claim 1, wherein the weakened section is formed on an adjoining section between the body section and the connecting section.

4. Connecting member as claimed in claim 1, wherein the weakened section is formed on a predetermined portion of the body section, the weakened section having a cross-sectional area smaller than that of other parts of the body section.

5. Connecting member as claimed in claim 1, wherein the weakened section has a cross-sectional area smaller than that of other parts of the connecting member.

6. Connecting member as claimed in claim 1, wherein the weakened section is a through hole passing through two opposite sides of the body section.

7. Connecting member as claimed in claim 1, wherein the weakened section is at least one channel formed on outer circumference of the body section with a predetermined depth and length.

8. Connecting member as claimed in claim 1, wherein the weakened section is an annular groove formed on outer circumference of the body section.

9. Connecting member as claimed in claim i, wherein the weakened section is a dent formed on outer circumference of the body section with a predetermined depth.

10. Connecting member as claimed in claim 1, wherein the circumference of the driven section and the circumference of the socket of the connecting section both have polygonal shape.

11. Connecting member as claimed in claim 1, wherein the socket of the connecting section has a hexagonal shape.

12. Connecting member as claimed in claim 1, wherein the body section has a lengthwise extending polygonal column section with a predetermined length, a predetermined length of the polygonal column extending between the weakened section and the connecting section.

13. Connecting member as claimed in claim 1, further comprising a resilient member disposed in the socket of the connecting section.

14. Connecting member as claimed in claim 1, further comprising a resilient member and a steel ball, the steel ball being positioned in a perforations passing through the inner and outer circumferences of the connecting section, the resilient member being disposed around the connecting section to resiliently force the steel ball to partially slightly protrude into the socket of the connecting section.

15. Connecting member as claimed in claim 1, wherein the weakened section is formed on the connecting section.

16. Connecting member as claimed in claim 15, wherein the weakened section has a cross-sectional area smaller than that of other parts of the connecting member.

17. Connecting member as claimed in claim 15, wherein the weakened section is at least one perforation passing through the inner and outer circumferences of the connecting section.

18. Connecting member as claimed in claim 15, wherein the
